(19) United States
(12) Patent Application Publication
(10) Pub. No.: US 2022/0195801 A1
(43) Pub. Date: Jun. 23, 2022

(54) ROTATABLE TOP TRAY ON A STEPPING STRUCTURE

(71) Applicant: Spartner Group, Inc., Chicago, IL (US)

(72) Inventors: Chad William Gericke, Chicago, IL (US); David Plotner, Louisville, KY (US)

(21) Appl. No.: 17/560,109

(22) Filed: Dec. 22, 2021

Related U.S. Application Data
(60) Provisional application No. 63/129,278, filed on Dec. 22, 2020.

(51) Int. Cl. E06C 7/14

(52) U.S. Cl. CPC E06C 7/14

(57) ABSTRACT

A stepping structure includes first and second side rails and a set of steps extending between the first and second side rails, a top tray, and a locking member on the upper end of the first side rail. The top tray includes a planar body having a first side surface and a second side surface opposite the first side surface. The top tray is configured to rotate between an extended position and a stored position. Actuation of the locking mechanism enables the top tray to move between the extended and stored positions. In the extended position, the second side surface of the planar body of the top tray is distal from the first and second side rails. In the stored position, the second side surface of the planar body of the top tray is adjacent to the first and second side rails.

### CROSS-REFERENCE TO PRIOR FILED APPLICATIONS

This application incorporates by reference and claims the benefit of priority to U.S. Provisional Application No. 63/129,278 filed Dec. 22, 2020.

### BACKGROUND

The present disclosure generally relates to ladders. More specifically, the present disclosure pertains to ladders including tool trays.

When undertaking projects on buildings, house maintenance, construction work, etc., workers often need easy access to items such as hand tools, appliances, and fasteners. When these tools are readily accessible to the worker, the project is completed more smoothly and quickly. Workers often utilize a tool holder, such as a tool belt or tool box, to hold the tools they need for the project.

Easy access to tools is important when working on a ladder in order to conveniently finish a project without needing to descend the ladder repeatedly. Some ladders on the market have a support surface on the top of the ladder on which tools may be placed. The support surface at the top of the ladder is typically secured in place relative to the side rails.

Some ladders include or allow for a tool holder extension to be attached to the support surface of the ladder. A tool holder extension that is removably attached to a support surface of the ladder is shown in FIG. 1. A tool holder extension that is an integral, foldable part of the support surface is shown in FIG. 2. A tool holder extension installed on the top of the ladder is shown in FIG. 3. These tool holder extensions provide additional support surfaces and/or compartments for tools.

However, tool trays that are removably attached to the ladder top may become weak or dislodged if the weight from the tools is too great for the connection point. The user must also remember to bring the extension in addition to the ladder, making its use inconvenient.

Therefore, a need exists for a simplified device for holding tools atop a ladder, as described herein.

### SUMMARY

According to one aspect of the present disclosure, a stepping structure may comprise first and second side rails and a set of steps extending therebetween and a rotatable top tray that moves between an extended position and a stored position. The top tray includes a planar body having a first side surface and a second side surface opposite the first side surface. The top tray extends between upper ends of the first and second side rails, and includes a locking mechanism on the upper end of the first side rail that enables the top tray to be secured and move between the extended and stored positions.

In the extended position, the planar body of the tray is parallel to the ground on which the ladder stands. The first side surface of the top tray extends between the first and second front side rails while the second side surface of the top tray is positioned in the air distal from the first and second front side rails.

In the stored position, the planar body of the tray is parallel to the first and second front side rails. The second side surface has rotated from the distal position in the air to a proximal position near the front side rails. Each of the first and second side surfaces and the planar body extends between the first and second front side rails as well, with the second side surface below the first side surface.

The locking mechanism includes a cylindrical member extended between the first and second side rails through an interior of the top tray. The top tray includes third and fourth side surfaces extending between the first and second side surfaces, and the cylindrical member extends through an arcuate cavity in the third side surface of the top tray. The member includes a narrow portion and a wide portion, and the arcuate cavity has a narrow length that leads to an enlarged end. The narrow portion of the member is movable through the narrow length of the arcuate cavity, and the wide portion of the member is received by the enlarged end of the arcuate cavity.

The locking mechanism also includes a spring mechanism that biases the cylindrical member away from the third side surface of the top tray, and therefore biases the wide portion of the member against the arcuate cavity. When the wide portion of the member is in the enlarged end of the arcuate cavity, the top tray is locked into the extended position.

By compressing the button, the wide portion of the member is withdrawn from the enlarged end of the cavity, allowing the narrow portion of the member to move into the narrow length of the arcuate cavity. The member then moves along the arcuate cavity and the top tray correspondingly rotates into the stored position.

In one embodiment, the stepping structure further includes third and fourth side rails that are pivotally attached to the first and second front side rails, respectively. The stepping structure may further comprise a further set of steps extending between the first and second rear side rails.

In one embodiment, the top tray may include at least one compartment is selected from the group consisting of at least one slot, at least one hole, at least one support surface, and combinations thereof.

In one embodiment, the at least one compartment may be configured to hold the tool selected from the group consisting of a hammer, a drill, a driver, a plier, a screwdriver, a tape measure, a fastener, a plumbing device, a caulking gun, and combinations thereof.

Additional features and advantages are described herein, and will be apparent from the following Detailed Description and the figures.

### BRIEF DESCRIPTION OF THE DRAWING

Features and advantages of the ladder tool tray described herein may be better understood by reference to the accompanying drawings in which:

FIGS. 1-3 illustrate a prior art ladder tool trays.

FIG. 4 illustrates an example embodiment of a ladder with the tool tray according to the present disclosure.

FIGS. 5 and 9 illustrate an enlarged view of the top of the ladder in FIG. 4 with the tool tray in a locked, extended position.

FIGS. 6 and 8 illustrate an enlarged view of the top of the ladder in FIG. 4 with the tool tray in an unlocked, stored position.

FIG. 7 illustrates an enlarged view of a locking mechanism of the ladder of FIG. 4.

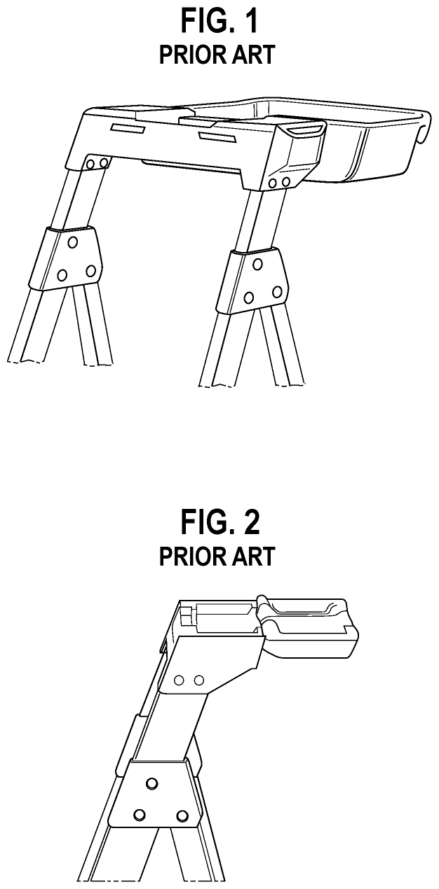

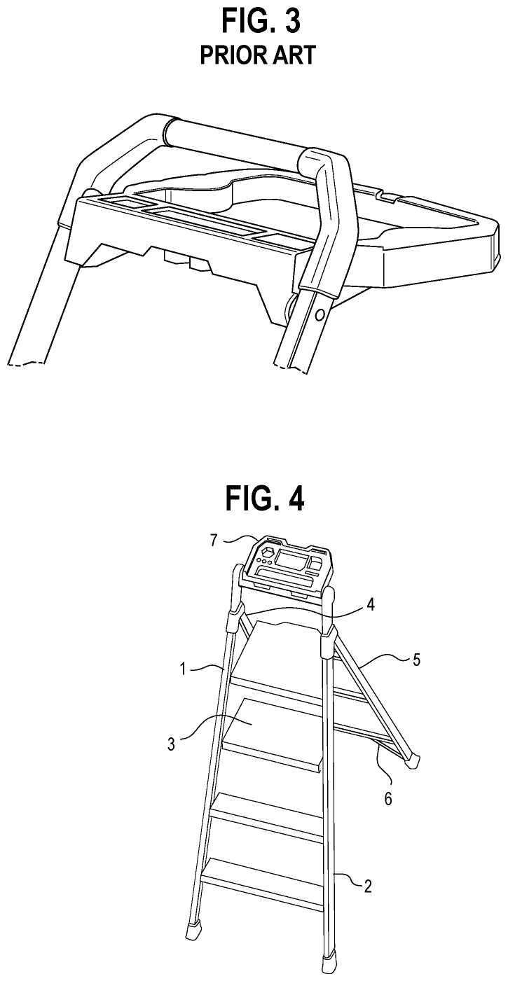

The reader will appreciate the foregoing details, as well as others, upon considering the following detailed description of certain non-limiting embodiments of the ladder with the tool tray according to the present disclosure. The reader may also comprehend certain of such additional details upon using the ladder tool holder described herein.

### DETAILED DESCRIPTION

Referring to FIGS. 4-9, the present disclosure provides a ladder tool tray that overcomes the problems of the tool trays in the market as described above. The disclosed rotatable tool tray is easy and convenient to use, compact, versatile, safe, and secure.

In a general aspect of the present disclosure shown in FIG. 4, a stepping structure 100 may include two front side rails 1, 2 and a set of steps 3 extending between the two front side rails 1, 2. The stepping structure may also include two rear side rails 4, 5 pivotally attached to the two front side rails, respectively. The stepping structure may also include a further set of steps 6 extending between the first and second rear side rails. In the illustrated embodiment, the stepping structure is a ladder although other structures such as step stools may also feature the rotatable tool tray described herein.

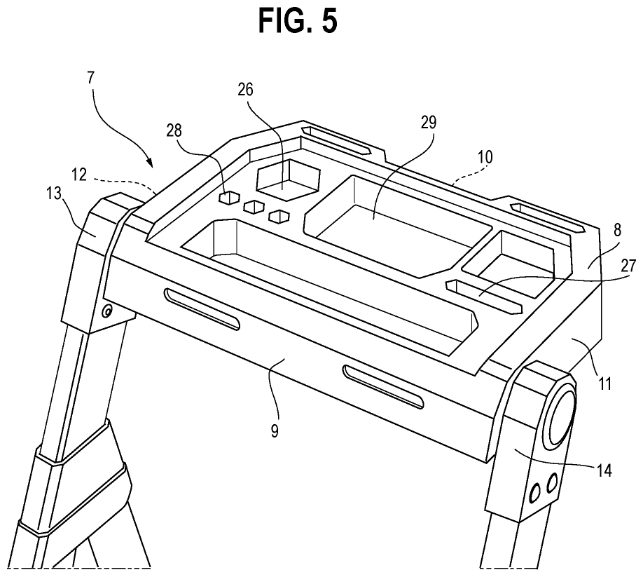

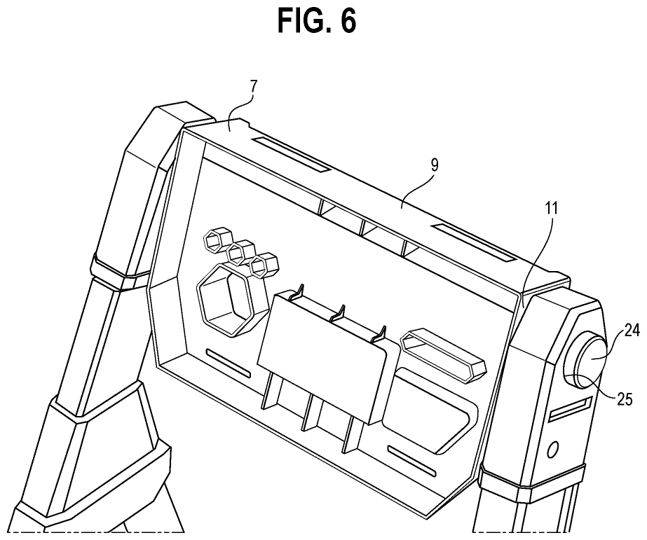

As shown in FIGS. 5 and 6, the rotatable tool tray 7 may include a planar body 8 having first through fourth side surfaces 9-12 opposite to each other. The first side surface 9 extends between the upper ends 13, 14 of the two front side rails 1, 2, and the second side surface 10 is parallel thereto. Third and fourth side surfaces 11, 12 extend between the first and second side surfaces 9, 10 and are opposite to one another.

In the illustrated embodiment, the tool tray 7 includes a number of compartments 26, cavities, slots 27, holes 28, openings, support surfaces 29 and the like for tool and equipment storage and organization. Non-limiting example tools that can be supported or held by the tool tray may include a hammer, a drill, a driver, a plier, a screwdriver, a tape measure, a fastener, a plumbing device, or a caulking gun.

The tool tray 7 may be attached to the stepping structure 100 in a way that allows the tool tray 7 to rotate between an extended position shown in FIG. 5 and a stored position shown in FIG. 6. In the illustrated embodiment, the tool tray 7 connects to each of the upper ends 13, 14 of the front side rails 1, 2 through a pin member or cylindrical member 15. Each of the third and fourth side surfaces 11, 12 includes a cavity 16 through which the cylindrical member 15 extends, and the inner surfaces of the upper end 13, 14 of the adjacent front side rail 1, 2 including openings through which the cylindrical member 15 extends. The tool tray rotates about an axis defined by the cylindrical member(s) 15. In other embodiments, a single cylindrical member extends between the upper ends 13, 14 of the front side rails 1, 2 and through the third and fourth side surfaces 11, 12 of the top tray 7.

In still further embodiments, at least one of the side surfaces 11, 12 includes a protrusion, a protruding rounded surface, or other extended surface and the adjacent end surface 13, 14 includes a corresponding mating surface such as an indentation or cavity for receiving the protrusion, the protruding rounded surface, or the other extended surface. In still further embodiments, at least one of the end surfaces 13, 14 includes a protrusion, a protruding rounded surface, or other extended surface and the adjacent side surface 11, 12 includes a corresponding mating surface such as an indentation or cavity for receiving the protrusion, the protruding rounded surface, or the other extended surface. In yet additional embodiments, other means of engagement may be used to rotatably connect the tool tray 7 to the upper ends 13, 14 of the first and second side rails 1, 2.

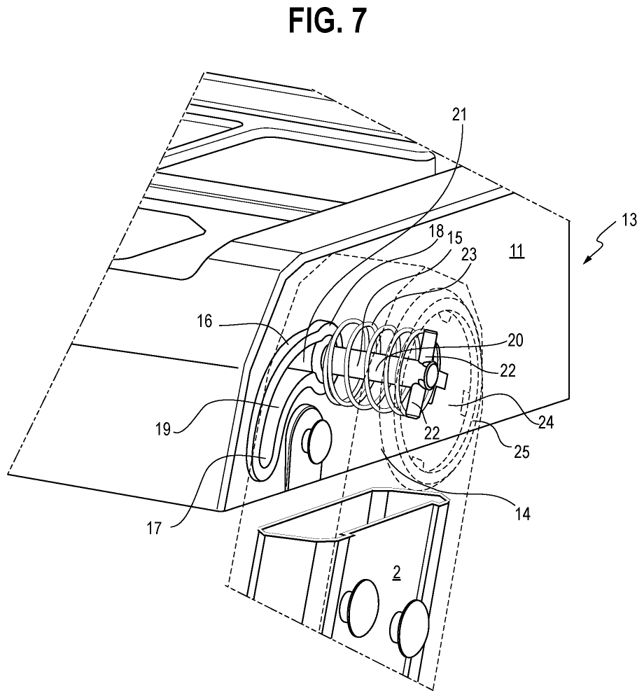

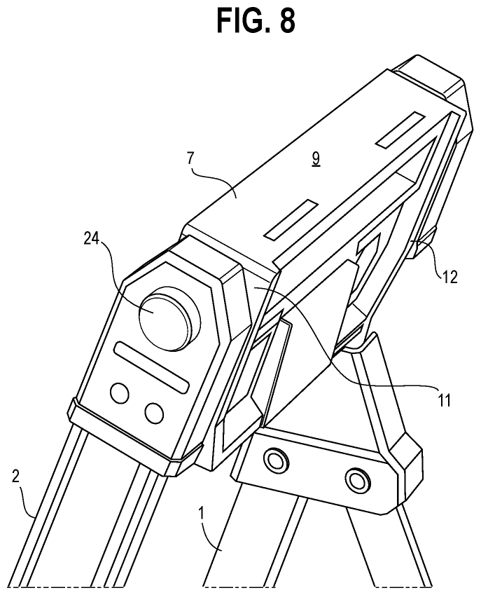

Referring to FIG. 7, the tool tray 7 also includes a locking mechanism 13 to lock the tool tray 7 in the extended position. On the third side surface 11 of the tool tray 7, the cavity 16 is arcuate in shape between first and second ends 17, 18, having a narrow length 19 from the first end 17 expanding to an enlarged rounded portion at the second end 18. The cylindrical member 15 includes a narrow portion 20 at a first end extending from a wide portion 21 at a second end. The narrow portion 20 of the member 15 is sized to fit within the narrow length 19 of the cavity 16, while the wide portion 21 of the member 15 is sized to fit within the enlarged second end 21. The second end of the member 15 extending into the upper end 14 of the second front side rail 2 includes a stop member 22 protruding transversely to a length of the cylindrical member 15. A spring 23 is positioned along the length of the cylindrical member 15 between the third side surface 11 and the stop member 22, biasing the member 15 away from the third side surface 11. When the wide portion 21 of the member 15 is received by the second end 18 of the cavity 16 in the third side surface 11, the tray top 7 is locked into the extended position shown in FIG. 5.

A push button 24 extends through an opening 25 in the outer surface of the upper end 14 of the second front side rail 2 and is positioned against the member 15. Depression of the push button 24 causes the member 15 to move inwardly to the interior of the tray top 7. More specifically, depression of the push button 24 causes the cylindrical member 15 to move inwardly such that the wide section 21 of the member 15 moves away from the cavity 16 and the narrow section 20 of the member 15 is positioned within the arcuate cavity 16 and is able to move into the narrow length 19 thereof. The tray top 7 may then be rotated about the arcuate shape 16 from the extended position of FIG. 5 to the stored position of FIG. 6. Any conventional push button 24 that includes a biased switch moving between an undepressed position and a depressed position can be used.

The illustrated embodiment includes a locking mechanism having a cylindrical member that extends through and moves along the arcuate cavity, with a spring and button to bias the cylindrical member into the locked and unlocked positions. In other embodiments, other locking mechanisms might be used.

In the extended position, the planar body 8 of the tool tray 7 is in the locked position, and the side surface 10 of the tool tray 7 extends into the air and substantially parallel to the ground surface, distal from the front side rails 1, 2 as shown in FIGS. 5 and 9. The tool tray 7 is locked in this extended position such that tools can be stored, held, or supported in the tool tray.

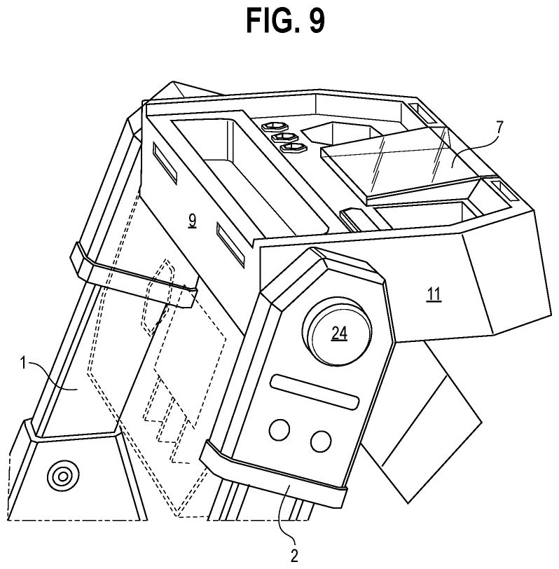

Once the tool tray 7 is unlocked from the extended position and rotated into the stored position, the side surface 10 of the planar body 8 is adjacent to the front side rails 1, 2 as shown in FIG. 6. Referring to FIG. 8, the side surfaces 11, 12 of the planar body 8 of the tool tray 7 may be aligned with first and second front side rails 1, 2. In this stored position, the top of the ladder no longer has an extended surface, and thus the ladder is in a compact configuration and can be easily moved around and/or stored in storage.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A stepping structure comprising:
first and second side rails and a set of steps extending between the first and second side rails, the first side rail including a first upper end and the second side rail including a second upper end;
a top tray including a planar body having a first side surface, a second side surface opposite the first side surface, a third surface spanning the first and second side surfaces, and a fourth surface opposite the third surface, wherein the first side surface extends between the first upper end and the second upper end of the first side rail and the second side rail, respectively, and wherein the third surface includes a cavity;
a cylindrical member including a first member end and a second member end opposite of the first member end, the first member end positioned within the cavity of the third side surface of the top tray, the second member end positioned within an opening on an inner surface of the first upper end of the first side rail, the cylindrical member defining an axis between the first upper end and the second upper end, wherein the top tray is configured to rotate about the axis between an extended position and a stored position;
a spring element positioned between a stopper on the second end of the cylindrical member and the third side surface of the top tray, the spring element configured to bias the cylindrical member toward the first upper end of the first side rail; and
a button on an outer surface of the first upper end of the first rail and opposite of the opening on the inner surface, wherein depression of the button causes the cylindrical member to move along the axis toward the top tray against a biasing force of the spring element;
wherein, when the top tray is in the extended position, the cylindrical member engages with the cavity to lock the top tray in the extended position; and
wherein, when the button is depressed, the top tray is unlocked from the locked position.

2. The stepping structure of claim 1, wherein, in the extended position, the second side surface of the planar body of the top tray is distal from the first and second side rails, and wherein, in the stored position, the second side surface of the planar body of the top tray is adjacent to the first and second side rails.

3. The stepping structure of claim 1, wherein the cavity comprises an arcuate cavity, and wherein the cylindrical member moves along the arcuate cavity between the extended and stored positions.

4. The stepping structure of claim 1, further comprising a further set of steps extending between the first and second rear side rails.

5. The stepping structure of claim 1, wherein the top tray includes at least one compartment is selected from the group consisting of at least one slot, at least one hole, at least one support surface, and combinations thereof.

6. A stepping structure comprising:
first and second side rails and at least one step extending between the first and second side rails;
a top tray including a planar body having first and second opposing side surfaces and third and fourth opposing side surfaces, wherein the top tray is rotatably connected to the first and second side rails, and wherein the top tray is configured to rotate between an extended position and a stored position; and
a locking mechanism on the first upper end of the first side rail, wherein actuation of the locking mechanism enables the top tray to move between the extended and stored positions.

7. The stepping structure of claim 6, wherein, in the extended position, the planar body is in a locked position having the second side surface of the top tray distal from the first and second side rails.

8. The stepping structure of claim 7, wherein, in the stored position, the planar body is in an unlocked position having the second side surface of the top tray adjacent to the first and second side rails.

9. The stepping structure of claim 8, wherein the top tray includes at least one compartment selected from the group consisting of at least one slot, at least one hole, at least one support surface, and combinations thereof.

10. A stepping structure comprising:
first and second side rails and a set of steps extending between the first and second side rails, the first side rail including a first upper end and the second side rail including a second upper end;
a top tray including a planar body having a first side surface, a second side surface opposite the first side surface, a third surface spanning the first and second side surfaces, and a fourth surface opposite the third surface, wherein the first side surface extends between the first upper end and the second upper end of the first side rail and the second side rail, respectively, and wherein the third surface includes an arcuate cavity having a narrow portion expanding to a wide portion;
a cylindrical member including a first member end and a second member end opposite of the first member end and having a first width adjacent the first member end and a second width adjacent the second member end, wherein the first width is greater than the second width, the first member end positioned within the arcuate cavity of the third side surface of the top tray, the second member end positioned within an opening on an inner surface of the first upper end of the first side rail, the cylindrical member defining an axis between the first upper end and the second upper end, wherein the top tray is configured to rotate about the axis between an extended position and a stored position;
a spring element positioned between a stopper on the second end of the cylindrical member and the third side surface of the top tray, the spring element configured to bias the cylindrical member toward the first upper end of the first side rail; and
a button on an outer surface of the first upper end of the first rail and opposite of the opening on the inner surface, wherein depression of the button causes the cylindrical member to move along the axis toward the top tray against a biasing force of the spring element;
wherein, when the first width of the cylindrical member is received by the wide portion of the cavity in the third side surface of the tray wall, the tool tray is locked in the extended position;
wherein, when depression of the button causes the cylindrical member to move along the axis toward the top tray, the second width of the cylindrical member is aligned with the cavity and enables rotation of the top tray about the axis.
